(19) United States
(12) Patent Application Publication
(10) Pub. No.: US 2012/0085695 A1
(43) Pub. Date: Apr. 12, 2012

(54) Carbon nanotube wetlaid depth media

(75) Inventors: Abhishek D. SAXENA, Somersworth, NH (US); David L. CARNAHAN, Needham, MA (US); Kapil KULKARNI, Waltham, MA (US); Stephen E. GROSS, Dover, NH (US)

(73) Assignees: NanoLab, Inc., Newton, MA (US); Lydall, Inc., Manchester, CT (US)

(21) Appl. No.: 12/901,892

(22) Filed: Oct. 11, 2010

(51) Int. Cl. B01D 39/06; B82Y 30/00

(52) U.S. Cl. 210/491; 210/505; 210/501; 977/902

(57) ABSTRACT

Disclosed is a media (such as a filter media) having one or more carbon nanotube (CNT)-containing layer. Each CNT-containing layer contains high temperature refractory fibers (e.g., staple quartz fibers and/or ceramic refractory fibers) that have melting temperatures greater than about 600° C. and in situ grown CNTs. Substantially all of the in situ grown CNTs have one end thereof associated with the fibers. This results in substantially all of the in situ grown CNTs extending away from substantially all of the fibers. Moreover, substantially all of the in situ grown CNTs are dispersed throughout the fibers. In one embodiment the media also includes one or more supporting layer. Each supporting layer contains high temperature refractory fibers that have melting temperatures greater than about 600° C., optionally bulk refractory fibers, optionally E-glass fibers, and optionally microglass fibers. The media can be tailored as a filter media to remove different size particles and have different dirt loading capacities depending upon the desire of the consumer.

### FIELD OF THE INVENTION

The present invention relates to a wet-laid depth media with in situ grown carbon nanotubes (CNT or CNTs) that can be used for high efficiency filtration such as virus removal from water or desalination of water currently served by membranes but with increased life span compared to commercially available membranes.

### BACKGROUND OF THE INVENTION

Water is one of the most basic human needs. Most humans cannot get access to the high-quality water they require. The scarcity of potable water coupled with increased water consumption has led to a worsening shortage. Under-developed countries depict this crisis at its most extreme. Critical health concerns arise from poor water quality in these countries. This is a global problem that must be addressed.

Over the last 35 years the Center for Disease Control (CDC) completed studies on the causes of waterborne outbreaks of disease. Their study between 1971 and 2000 found bacteria caused 13% of waterborne disease while viruses contributed to 7%. The CDC could not ascertain the cause for 50% of the outbreaks. Most experts believe the percentage of outbreaks due to these microbiological contaminants was much higher than 20%, as past detection methods were incapable of detecting many bacteria and viruses.

The water industry is quite complex, and consumers can draw water from a number of sources. Large municipal treatment facilities, smaller community water systems, and individual wells are most common. More recent studies revealed all categories of source water are subject to contamination. Of the 183 disease outbreaks from 1991 to 2002 a total of 18% were due to surface water while 76% were due to groundwater sources, a surprising result as groundwater was previously viewed as pathogen free. A number of published studies revealed viruses present in eight to 50 percent of tested utility and homeowner wells.

U.S. Environmental Protection Agency (“EPA”) regulations and the preferred treatment methods protecting municipal drinking water quality continue to evolve. The EPA's revised water treatment rules, including the Long Term 2 Enhanced Surface Water Treatment Rule (LT2ESWTR), Stage 2 Disinfection Byproducts Rule, and Ground Water Rule, continue to improve the water quality of those connected to public water supply. Nonetheless, the deterioration of the supply infrastructure is a major concern, as the EPA found 19% of U.S. outbreaks are linked to distribution issues between the municipal facility and Point of Use (“POU”). Within distribution pipes biofilms can rapidly form robust structures that release bacteria into drinking water.

Individual wells and small community systems serving less than 25 people or 15 service connections fall outside of EPA regulations. The EPA estimates approximately 15% of Americans, approximately 45 million individuals, rely upon their own water supply. Contamination issues and consumer knowledge are significant concerns. These individuals are solely responsible for their water quality. Recent estimates place more than half of all new homes off the municipal water grid.

In 1987 the EPA published the Guide Standard and Protocol for Testing Microbiological Water Purifiers, and in 2003 the U.S. National Science Foundation (“NSF”) published Protocol P231 based on the EPA guidelines. Discussions continue toward the goal of establishing P231 as a full standard. A number of technologies emerged over the last five years addressing the need for microbiological purification in the home. Ultraviolet (UV) light disinfection, membrane separation, biocide media, and depth filtration media represent the most prevalent technologies. Reverse osmosis (RO), ultrafiltration (UF) hollow-fibers, and UF flat sheets are candidate membrane types. Depth filters such as zeta-potential and nano-fiber flat sheets are emerging approaches. Many of these technologies can also be combined in a system approach.

UV sterilization experienced widespread adoption as a municipal and industrial approach to purification in Europe and is rapidly emerging in the same applications in the U.S. UV light sterilization units for individual consumers have been on the market for a number of years. At proper dosage levels UV light is a powerful killing agent for bacteria and virus. Microbial DNA is rearranged by UV light which prevents reproduction. These units are capable of high flow rates. UV units are moderately expensive, and require the replacement of UV bulbs and pre-filters. There are a number of limitations to using a UV system as the sole means of microbiological purification. Microbes can effectively hide behind particles in turbid water. Pre-filters alleviate this issue, but the <100 nm size of many viruses is a challenge. Research determined certain double-stranded viruses repair their DNA after UV treatment. Some bacteria resist UV sterilization, and there has been some discussion about raising the required dosage from 40 mJ/cm². The enhancement in purification would be offset by a substantial increase in operating costs due to bulb replacement expense and increased energy demands. The technology is not considered fail-safe as a loss of UV power does not stop the flow of drinking water. For these reasons stand-alone UV does not meet P231 requirements for purification.

Bactericides and biocides are popular methods for ultrapure and municipal water treatment methods. Silver (Ag) acts as an antimicrobial by interrupting cellular division in bacteria. Point of Entry (POE) and POE microbiological purifier candidate technologies blend some combination of resins, zeolites, metals and metal oxides, with silver. Providing a long enough dwell time to adequately kill bacteria and virus is a challenge. Doing so increases filter size and cost. Because the technology is chemical, as opposed to physical separation, filters using this technology have not offered fail-safe purification per P231 standards.

Reverse osmosis (RO) technology is at the extreme end of the membrane performance scale as can be seen for instance in FIG. 1. These membranes are capable of rejecting dissolved solids such as salt molecules and metals in the single-digit Angstrom size range. High-end RO membranes form the basis for large-scale desalination and municipal water treatment facilities. A typical perforated membrane 30 that may be useful for instance in a RO system can be seen in FIG. 2, which is a top view of the membrane using a Scanning Electron Micrograph (SEM). The membrane 30 as shown herein has been perforated with multiple holes 31. As shown in FIG. 3, the pictorial representation or illustration of FIG. 2 from a side view, the membrane 30 is shown with holes 31 extending from the upstream or top side 32 of the membrane through the downstream or bottom side 34 of the membrane. As larger particles 40 and smaller particles 41, which are suspended in a fluid 50 (e.g., air, water, liquid, etc.) approach the membrane 30, the larger particles 40 are trapped on the upstream side of the membrane, and thus only smaller particles 41 are allowed to pass through the holes 31 of the membrane 30.

A number of manufacturers offer more economical RO membranes for household RO systems. Under-the-sink consumer RO systems are popular among well users for their removal of dissolved contaminants. RO systems are relatively complex and expensive to operate. Given their contaminant rejection characteristics RO membranes are logical options for microbiological purifiers. However, issues with their construction and consistency eliminate this consideration. The integrity of O-ring seals at the ends of the wound membranes is a concern. More concerning, these economical films form with minor imperfections in their surface. This is not an issue for the removal of dissolved salts and elements, as typical rejection rates range from 90-99% for these contaminants. The imperfections become a limiting issue as enough bacteria and viruses can pass through to violate the requirements of 99.9999% and 99.99% removal, respectively, for the P231 protocol.

Depth filtration media differs from membranes in construction and performance. FIG. 4 shows a typical depth filtration media 60 of the prior art wherein different sized fibers are formed into a depth filtration media 60. As shown by the arrows 15, the fluid containing particles enters the upstream side of the depth filtration media 60, and larger particles 40 are trapped within the depth filtration media 60, while smaller particles 41 pass through the depth filtration media 60. Membranes work via pure size exclusion along the surface layer while depth filters capture particles within a tortuous three dimensional matrix of fibers. Depth filters work by direct flow. Sub-micron rated products incorporate microglass fibers, synthetic meltblowns, synthetic nanofibers, or a combination of these technologies. Microglass is preferred as the short, fine diameter fibers create a high efficiency sheet with very high (>80%) porosity. This results in a filter media with high particle retention capacity and high flow rates. Current wet-laid non-woven microglass technology without any filter-aid additives is capable of 6 log bacteria removal. Such cartridges have been available in the market for a number of years. However, this technology has reached its practical performance limit, as efforts to push the technology further down the particle filtration scale have been unsuccessful.

A review of filtration theories (e.g Langmuir, Davies, Happel, Kuwabara, etc.) reveal that the fiber diameter is the dominant factor affecting the filtration properties of fibrous filter media. In the models of Langmuir, Happel and Kuwabara, porosity is assumed from the diameter of the fiber and the surrounding void space. Peart and Ludwig reported that number of fibers and the number of pores in a medium can be related to fiber diameter as follows:

N_{f}=4Mₛ/πρ_{f}D_{f}²L_{f}²

Nₚ=16M²s L_{f}/π³ρ_{f}D_{f}⁴
N_{f} is the number of fibers per unit area (m²) of medium
Nₚ is the number of pores per unit area (m²) of medium
D_{f} is the fiber diameter (m)
Mₛ is the grammage of the medium (gm/cm³)
L_{f} is the fiber length (m)
ρ_{f} is the density of the fiber (gm/cm³).

Depending on the porosity, fiber diameter is inversely related to the flow resistance of a web made from the fibers: that is the smaller the diameter, the greater is the resistance. The density of these nonwoven webs tends to increase with decreasing fiber diameter. On the other hand, reducing fiber diameter is the dominant way of increasing filtration efficiency of nonwoven filter media (Handbook of Nonwoven Filter Media, Irwin M. Hutten, Published 2007).

Filtration efficiency in wet-laid microglass media is restricted by the diameter of the microglass which is 0.2 micron for the smallest diameter fiber. Since filtration efficiency is highly correlated with fiber diameter, in order to achieve higher filtration efficiency, a number of companies have incorporated filter-aid additives into standard micro-glass sheets. These particles, which are typically nano-sized alumina, create an electrostatic, or zeta, potential within the filter matrix. The positive charge has high affinity for capturing negatively charged particles within an aqueous solution. This construction provides high efficiency for virus and bacteria removal with the flow rates of a more open 1-2 μm rated filter media. These zeta potential filters work through a combination of charge and mechanical sieving. They are not considered fail-safe as water can pass through the structure as the charge reduces during use and the electrostatic potential varies according to the pH of the water. Source water pH varies across municipalities and individual wells, and under certain conditions the effect of the charge is mitigated. These zeta potential media have not met P231 requirements. Manufacturers improve the performance of these sheets by bulking up the media. This increases the charge capacity of the structure, but results in additional cost and difficulties in processing the sheet into a filter cartridge. Thick media is particularly difficult to pleat or wrap into smaller cartridge formats.

In order to achieve better filtration efficiencies in a depth filter media such as wet-laid microglass filter media, the filtration mechanisms call for a fiber with much smaller fiber diameter than microglass. Current existing technologies that produce such fibers include: electrospinning, chemical vapor deposition (CVD), Atmospheric pressure CVD and Plasma Enhanced CVD.

Carbon nanotubes (CNTs) are nanofibers that offer unique filtration characteristics. Carbon nanotubes can be used as a fiber for forming nonwoven structures. The high aspect ratio (length/diameter) for carbon nanotubes is typically >2000, so these CNTs represent a considerable advancement over other state of the art nanofibers. When CNTs are formed into a sheet, which is commonly referred to as “buckypaper”, the CNTs form a network that can be extremely dense with pore sizes less than 100 nm. FIG. 5 shows a SEM of an example of a typical commercially available buckypaper made of CNTs 13 of the prior art. Buckypaper easily exceeds 4 log targets for virus removal in water filtration, but is however restricted by limitations of scale up for volume. The primary restriction in scale up of buckypaper formation is the drainage time required to remove the dispersant fluid and that it requires a membrane filter to collect the CNTs and form the wet-laid structure of a paper.

There are other approaches as explained in the U.S. Pat. No. 7,419,601 to Cooper, et al. which combines commercially available CNTs with other fibers to form a dispersion of the CNTs and other fibers, and then form a filtration layer by vacuum filtration through, for instance, a cylindrical carbon block or a nonwoven carbon fabric. In another approach as explained in U.S. patent application Ser. No. 11/193,340, published as U.S. Publication No. 2006/0027499 to Ajayan, et al., radially aligned CNTs were fabricated to make filter media. A number of patent applications aimed at use of CNTs in filtration have been filed. However, none of these applications utilize CNTs grown in situ by dispersal of catalyst throughout the material. For instance, in U.S. Pat. No. 7,419,601 to Cooper, et al., already prepared or pre-manufactured CNTs are simply dispersed with, for instance glass fibers, and then deposited on a carbon block or fabric, rather than being grown within the article.

All the processes mentioned utilize CNTs that are pre-manufactured to make a filter media out of them. Some limitations plague the immediate scale up of these technologies to make commercial filter media in larger volume, such as dispersion of CNTs, availability of CNTs, and the like.

One approach is mentioned by U.S. Pat. Nos. 6,824,689 and 7,011,760 to Wang, et. al., (“the Battelle Patents”) which provide a process of making a porous, carbon nanotube-containing structure, including a support material having through-porosity; depositing seed particles on the support material to form a seeded support material; and heating the support material and simultaneously exposing the seeded support to a carbon nanotube precursor gas to grow carbon nanotubes on the surface of the seeded support material. The porous substrate utilized by the Battelle Patents is metal foam or a ceramic membrane with catalyst seeds. The potential applications described include use of this structure with CNTs in filtration. However there are some drawbacks in the design specifically for filtration applications. Typical filtration applications such as water filters require a filter medium to do the filtration. This filter medium, as explained earlier could be ultraviolet (UV) light disinfection, membrane separation, biocide media, and depth filtration media such as wet-laid microglass, and the like. One immediate drawback of metal foam based filter medium is the scale up of the medium to meet filtration demands. From a filter design point of view a lot more development will be required to make this medium acceptable to fit current products. The ceramic membrane based media of the Battelle Patents calls for a coating of the ceramic membrane with mesoporous silica to substantially fill the large pore of the membrane and then depositing previously grown CNTs over the membrane, to achieve filtration efficiency. This extra step in the process to potentially make the membrane an efficient filter media adds to the cost and further complications to make the product. Also, the media described in the Battelle Patents would only result in making a high efficiency filter medium, and those filtration ranges are already being served by membranes.

What is needed is a depth filtration media capable of overcoming the shortcomings of the prior art, particularly one that is able to remove virus-sized particles, without unacceptable loss of pressure across the filtration media.

### SUMMARY OF THE INVENTION

In one embodiment, the present invention relates to a media, comprising: one or more carbon nanotube (CNT)-containing layer, comprising: high temperature refractory fibers that have melting temperatures greater than about 600° C.; and in situ grown CNTs.

In another embodiment, the high temperature fibers comprise one or more of staple quartz fibers and ceramic refractory fibers.

In another embodiment, the media further comprises: one or more supporting layer, comprising: high temperature refractory fibers that have melting temperatures greater than about 600° C.; optionally bulk refractory fibers; optionally E-glass fibers; and optionally microglass fibers.

In another embodiment, the microglass fibers have a softening point of about 1000° F. (537.8° C.).

In another embodiment, the media removes viruses from water.

In another embodiment, substantially all of the in situ grown CNTs have one end thereof associated with the fibers.

In yet another embodiment, substantially all of the in situ grown CNTs extend away from the fibers.

In yet another embodiment, substantially all of the in situ grown CNTs are dispersed throughout the fibers.

In another embodiment, the media is a filter media.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures wherein:

FIG. 1 is a chart comparing different particle size removal ranges by different types of filtration according to the prior art, including filtration ranges of Microglass Media of the prior art, and CNT Media according to the present invention.

FIG. 2 is about a 10000 fold magnification scanning electron microscope (SEM) image of a top view of a perforated membrane of the prior art.

FIG. 3 is an illustration of a side view of a membrane of FIG. 2.

FIG. 4 is an illustration of a side view of a depth filtration media of the prior art.

FIG. 5 is about a 10000 fold magnification SEM image of a top view of buckypaper of the prior art.

FIG. 6 is an illustration of a side view of a top layer of the present invention containing a catalyst prior to CNT growth according to one aspect of the present invention.

FIG. 7 is an illustration of a process for producing the catalyst loaded media according to one aspect of the present invention.

FIG. 8 is a 2000 fold magnification SEM image of a top layer according to one aspect of of the present invention prior to CNT growth.

FIG. 9 is an illustration of a side view of a top layer according to one aspect of the present invention.

FIG. 10 is an illustration of a side view of a dual layer structure according to one aspect of the present invention.

FIG. 11 is a 2000 fold magnification SEM image top layer according to one aspect of the present invention, wherein the CNTs have been grown in situ on the fibers of the media.

FIG. 12 is a 10000 fold magnification of the SEM image of the top layer of FIG. 11 according to one aspect of the present invention.

FIG. 13 is an illustration of a side view of a CNT media including a dual layer structure sandwiched between two meltblown layers according to one aspect of the present invention.

FIG. 14 is a graph showing Flat Sheet Virus Removal for two CNT Samples.

FIG. 15 is a graph showing Mean Flow Pore Size analysis by Capillary Flow Porometry.

### NOTATION AND NOMENCLATURE

Certain terms are used throughout the following description and claims to refer to particular components. As one skilled in the art will appreciate, different companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . ”.

### DETAILED DESCRIPTION OF THE INVENTION

Reference will now be made in detail to the presently preferred embodiments of the invention, one or more examples of which are illustrated in the drawings. Each example is provided by way of explanation, and is not meant as a limitation of the invention. For example, features illustrated or described as part of one embodiment can be used on or in conjunction with other embodiments to yield yet a further embodiment. It is intended that the present invention include such modifications and variations. When referring to the Figures, like numerals indicate corresponding parts throughout the several views.

CNTs are incorporated into a matrix of a wet-laid depth filter media via in situ growth to form a CNT-containing media according to one aspect of the present invention. The resulting media considerably advances filtration performance, by incorporation of very fine fibers in the form of CNTs. At the same time this media can potentially compete with membranes in efficiency while still maintaining the advantage of longer life span and/or high dirt loading and/or high particle retention capacity offered by a depth filter media. In fact, depending upon the desired application, the media according to one aspect of the present invention can be tailored to exhibit different dirt loading and particle size filtration properties.

In the Examples below, as well as in the specification and claims, all parts and percentages are by weight unless otherwise stated.

### CNT-Containing Layer

The main feature according to one aspect of the present invention is the CNT-Containing Layer so-called since it will eventually contain the CNTs. Of course, when first manufactured, this layer contains only catalyst particles and not in situ grown CNTs. The CNT-Containing Layer comprises catalyst for the growth of the CNTs as well as supporting fibers, which form a catalyst support structure or layer (as will be discussed in detail below).

This catalyst loaded layer is exposed to CNT precursor gases (as will be discussed in further detail below) in a CVD environment for the in situ growth of CNTs. Thus, the CNT-Containing Layer initially includes the catalyst support structure, catalyst, and optionally a binder (as will be described in detail below), and once formed, includes the catalyst support structure and in situ grown CNTs.

### Catalyst for Growth of CNTs

Catalysts for the growth of carbon nanotubes by chemical vapor deposition are any that are conventionally known, including, but not limited to that described in U.S. Pat. No. 7,157,068, to Li et al., entitled, “Varied morphology carbon nanotubes and method for their manufacture.” These catalysts include, but are not limited to, nanoparticles of iron, nickel, cobalt and alloys thereof, deposited on catalyst supporting structures that may include oxides, sulfides, carbides, nitrides. Further distinction is drawn to silicon oxides and aluminum oxides as catalyst supporting structures/materials. Particle sizes of these components typically range between about 0.01 and about 100 microns. Due to their particulate and porous nature, these metal nanoparticles provide a catalyst surface area (relative to the weight of the catalyst supporting structure/substrate) that is substantially higher than can be achieved by depositing catalyst metal directly on the fibers. The metal nanoparticles used according to one aspect of the present invention have primary particle sizes near about 0.01micron, but are aggregated in the drying process into porous structures in the 1-10 micron size range, so they can be caught by the CNT-Containing Layer.

A typical preparation of a catalyst involves the preparation of a slurry, a suspension of the catalyst supporting structures in water, followed by the addition of a dissolved metal salt, such as iron nitrate or iron sulfate. The preparation is then dried, ground and calcined to yield a small particle size, high surface area, catalyst oxide.

As the exposed surface area of the catalyst is proportionally related to the particle size of the metal nanoparticles, methods that create finer particles of the catalyst increase the yield of carbon nanotubes for a given amount of catalyst. There are a number of methods to remove water from a slurry and result in fine particles. Among these methods, spray drying is one of the most beneficial. A spray dryer converts a slurry to a dry powder by pumping the slurry through a nozzle, which atomizes the slurry into droplets. The droplets encounter a stream of heated air in the drier, which evaporates the liquid components of the droplets, concentrating the solids until they form solid particles, which are collected. The final particle size distribution is a function of the size of the droplets, and of the solids concentration, and the spray dryer design.

In the preparation of catalysts, the use of a spray drier replaces the drying, grinding and calcining steps with a single operation. Optimization of the spray drying process for CNT-forming catalysts required maximizing the yield of catalyst particles less than 10 microns in size, which was accomplished by adjusting the slurry concentration and the spraying conditions to achieve the finest atomization possible, as would be understood by one of ordinary skill in the art.

The catalyst, after being dried, ground and calcined, or after being processed in a spray dryer, is in oxide form. The catalyst is calcined and activated upon reduction of the oxide to the base metal. This can be accomplished by exposing the oxide catalyst to a reducing agent, such as hydrogen or ammonia, at an elevated temperature, typically between 400 and 700° C. Once in this activated state, carbon nanotubes can be grown from these catalysts. The lower temperature limit is the lowest temperature at which iron oxide will be reduced by flowing hydrogen or ammonia gas, which is observed experimentally to be ˜400° C. The high temperature limit is chosen to avoid sintering of the catalyst particles, which is observed to be ˜700° C.

The sub-10 micron sizes for the catalyst metal nanoparticles, which are preferred for CNT growth, are thus prepared, and are then redispersed in a slurry form for the preparation of a catalyst filled wet laid nonwoven material, which forms a secondary structure to support the catalyst supporting structure/particle.

### Fibers for CNT-Containing Layer

The catalyst support structure may be constructed from a single layer of a wet-laid nonwoven material, which can be constructed such that it has the ability to uniformly carry and disperse the finely divided, particulate, solid catalyst. Preferably, this material can retain the particles and sustain temperatures in excess of 600° C. while retaining the required physical properties. A temperature of 600° C. is preferably selected as this is the temperature at which the CNTs are formed.

In one embodiment, the fibers are high-temperature fibers or so-called refractory fibers. Such fibers are generally inorganic and are able to withstand the high temperatures imposed by the in situ growth of the CNTs. In one example, the fibers comprise staple quartz fibers (104 Q fiber commercially available from Johns Manville) and ceramic refractory fibers (FIBERFRAX® HSA™ FIBERS: HSA-HP commercially available from Unifrax) with small diameters, which fibers can sustain temperatures in excess of 600° C. Preferably, the quartz and ceramic fibers have an average diameter of between about 0.1 and 4 microns, more preferably between about 0.1 and 3 microns, due to improved processability in these size ranges.

The percentages of the fibers in the layers can vary considerably, but it is preferred that the percent by weight of the refractory fibers is about 10 to 40% and the percentage by weight of the quartz fibers is about 15 to 50% by weight.

Most preferable, the quartz fibers are substantially melt blown fibers with a high melting temperature (as described in more detail below). The melt blowing process is well known to the art and need not be described herein. While these fibers are referred to as “quartz fibers” in the art, they are not, in fact, necessarily pure natural quartz, but may be manufactured silica fibers, and in this case, preferably, amorphous silica fibers, with a high melting temperature. The melting temperature of the particularly preferred quartz fibers is about 3000° F. (1649° C.), e.g. from about 2500 to 3500° F. (1371 to 1927° C.). However, the quartz fibers may be of a lower melting temperature e.g about 1500° F. (816° C.) or greater.

While the quartz fibers can vary in diameter, and will vary in diameter according to the particular bulk forming process, e.g., the particular melt blowing or spinning process, it is preferred that the quartz fibers have an average diameter between about 0.1 and 4 microns, especially between about 0.5 and 2 microns. With such very small diameter fibers, the CNT-Containing Layer will be formed into a non-woven layer, as described more fully hereinafter, with small pores, the pores having a range of 0.035 to 5 microns, preferably 0.035 to 2 microns. In one embodiment, the base media or CNT-Containing Layer had an average pore size of about 2 microns, and once the CNTs were grown upon the media, the pore size was reduced to about 35 nm (0.035 microns). These small pores will allow and promote uniform dispersal of finely divided, particulate solids therein.

The fibers are also preferably able to be disposed, by certain processes described hereinafter, in such an array that the fibers can carry and retain the uniformly dispersed, finely divided, particulate, solid catalyst therein, with that disposition placing the catalyst particles very close to each other, but not touching. Thus, for a catalytic reaction, for the formation of CNTs, the fibers provide well dispersed but closely adjacent catalytic particles. That is, the catalytic particles can be positioned from about an average of 0.5 to 2 microns apart, although they could be as much as about an average of 7 or 8 microns apart and for some applications, other than carbon nanotubes, they could be much further apart, e.g., up to an average of about 15 or 20 microns apart. In such case, quartz fibers of greater diameter could be used. It has been found that the pores formed by such quartz fibers are so small and uniform that substantially only one catalyst particle will reside in one pore.

The CNT-Containing Layer will thus, uniformly disperse and firmly hold the finely divided, particulate, solid catalyst. In one embodiment, this CNT-Containing Layer is reinforced with one or more additional layers to improve the physical properties of the product.

In different embodiments, either one CNT-Containing Layer, or multiple CNT-Containing Layers may be used.

The particles of the catalyst are preferably retained in the CNT-Containing Layer. Without intending to be bound by the theory, it is believed that the catalyst particles are caught by the pores in the microglass, and retained there. The catalyst particles themselves have a support structure and do not necessarily depend on the fiber as a support. Thus, the CNT-Containing Layer (and indeed any layers included in the final product) can be tailored to have a desired mean pore size. In one embodiment the CNT-Containing Layer will have a very small mean pore size, particularly a mean pore size between about 0.5 and 5 microns. This will prevent the small catalytic particles from substantially departing the CNT-Containing Layer. This is particularly true when the mean pore size of the layers is about 1 micron. Further, in this regard, it is preferred that the largest continuous pore size (from one side of the layer to the other) does not exceed about 25 microns.

It is preferred that the CNT-Containing Layer has certain physical properties in order to be processed, loaded with the catalyst particles, and heated to temperatures suitable for chemical vapor deposition reactions, especially temperatures in excess of 1200° F. (649° C.) for producing CNTs. To this end, the layer preferably has a longitudinal tensile strength (in the machine direction as being processed and is explained below) of at least 750 grams per inch and tensiles up to 5000 are quite good. Somewhat similarly, longitudinal stiffness of the layer should be at least 500 milligrams and up to 1500 milligrams, after the layer is subjected to a temperature of about 1200° F. (649° C.) for 2 hours.

### Optional Binder

An organic binder may optionally be included in the CNT-Containing Layer. This will allow for optionally binding the catalyst support structure (“top layer”) more tightly together, especially during processing. In addition, since the CNT-Containing Layer is preferably useful for catalytic purposes and especially chemical vapor deposition reactions, there are preferably few organic impurities therein. Accordingly, the layer should have a loss on ignition in a muffle furnace at 1000° F. (537.8° C.) of no more than 15% and typically about 7% or less. In other words, when a binder is used it is preferred that the binder be burned off so as to not contaminate the layer during catalytic activity. For this reason a relatively fugitive binder, such as an acrylic organic binder, is preferred. However, the binder may be chosen from any one or more of conventional polymeric latex binders used in the paper arts, such as olefins and vinyls.

### CNT Growth in the CNT-Containing Layer

The synthesis of CNTs may be carried out in a chemical vapor deposition (CVD) reactor. CNTs can be synthesized by CVD in a broad range of temperatures, pressures and gas compositions, but the structure of the carbon nanotubes created varies depending on the exact conditions used. The diameter of the carbon nanotubes thus grown in situ is directly and proportionally related to the size of the iron nanoparticle catalysts on the particles of the catalyst support structure (“top layer”). Once nucleated at the iron nanoparticle catalyst sites, the carbon nanotubes grow in length at a rate which can be regulated by the temperature, pressure, gas flow rate and gas composition as will be understood by one of ordinary skill in the art. Regulation of the rate and time of carbon nanotube growth can be used to control the length and resulting weight percentage of the carbon nanotubes in the catalyzed media.

The growth mechanism for CNTs obtained by the methods of this invention likely involves the growth of carbon nanotubes from the surface of the catalyst support structure in a tip growth mode, meaning the CNT may grow distally from the fiber(s). The carbon source, usually in the form of a reaction gas (such as acetylene as described in greater detail below), breaks down at the catalyst surface, and its atoms diffuse through or over the surface of the catalytic particle. Upon reaching the other side of the media, the carbon is precipitated as a CNT. Both the diffusion rate and the carbon source concentration influence the growth rate of the CNT. The reaction gas pressure regulates the carbon atom concentration, which influences the morphology of the CNT. At low pressure, the carbon concentration is low, so both dissolution of the carbon into the catalyst and diffusion through the catalyst are limited; carbon atoms may participate in surface diffusion only, and thereby precipitate to form hollow CNTs only. In practice, hollow nanotubes are obtained at pressures below 20 Torr.

At higher reaction gas pressures, greater than 20 Torr, the carbon atom concentration is higher, which leads to an increased dissolution rate into the catalyst particles. The carbon atoms can diffuse throughout the catalyst particles, where the carbon may precipitate, forming a hemispherical shell around the catalyst particle. However, because the diffusion distance is shorter to reach the edges of the hemispherical shell, a cup shaped structure is grown, which broadens, eventually growing larger than the catalyst particle. The process then repeats, creating a ‘stack of cups’ structure that is separated by a fixed distance along the growth axis, resulting in a “bamboo-like” CNT with uniform density of compartments. CNTs grown at high pressure therefore, have high compartmental density, which is indicative of the graphene layers being steeply inclined to the growth axis of the carbon nanotube.

Temperature also has a similar role, accelerating decomposition of the carbon source at the catalyst particle and also accelerating diffusion of the carbon through the catalyst. The temperature required for CVD growth appears to have a minimum near 550° C., and nanotubes can be synthesized up to 1000° C. Higher synthesis temperatures do not seem to promote high yields over these catalysts. The highest yield, where yield is defined as the grams of carbon nanotubes synthesized per gram of catalyst, appears to be in the vicinity of 600-750° C.

The composition of the reaction gas used in the present invention may be any conventional composition, for example, the reaction gas may be either acetylene only, or acetylene combined with the use of a promoter gas, such as hydrogen or ammonia (which promoter gas can be added to maintain the catalyst in its most active form). For the growth of nanotubes in the quartz fiber media, it has been observed that growth conditions where both ammonia and acetylene are present during the synthesis provide a better yield of CNTs.

Because the nanotubes grow in length at a given rate, the process time is directly related to the mass yield of the carbon nanotubes, and therefore the amount or weight of carbon nanotubes in the fiber media/catalyst support structure can be controlled by process time. For filtration applications, it has been observed that with increasing growth time, the pore size and porosity of the media is reduced. However, excessive process time results in a condition where the integrity of the fiber media is compromised. So an optimal weight of nanotubes per unit area is expected, where the growth is sufficient to reduce the effective pore size to that required for the application, but not so much as to disrupt the media. In practice, between 5 and 30 weight percent nanotubes is sufficient to tighten the pore size sufficiently without disturbing the media.

Further details of the growth conditions for carbon nanotubes are found in U.S. Pat. No. 7,157,068 to Li et al., entitled, “Varied morphology carbon nanotubes and method for their manufacture.”

In one embodiment, when the catalyst particles are dispersed in the CNT-Containing Layer (prior to growth of the CNTs), the catalyst particles will each associate with fibers within the layer. The association of the catalyst particles to the fibers may be by way of any type of bonding, such as covalent bonding, ionic bonding, van der Waal forces, and the like. It is also possible that the catalyst particles may only be in physical contact with the fibers, and possibly further that the melting of the glass could partially encapsulate the catalyst particles.

In this manner, CNTs will grow from the catalyst particles. Thus, a substantial portion of the CNTs will each have one end associated with the fibers of the resulting CNT-Containing Layer. These CNTs will thus extend away from the fibers. In other words, the catalyst particles, which contain a support particle and the catalytic metal are caught in the pores of the catalyst support structure. This is in contrast to layers which might be prepared by dispersing CNTs in the layer itself. Such a dispersal of CNTs will simply provide an orientation of CNTs which is tangential to the fibers, without the ends of a substantial portion of the CNTs being associated with the fibers themselves. This is also in contrast to any layers prepared by depositing catalyst particles on or over the surface of the layer and then performing CNT growth. Although such CNTs may grow into the actual layer, they will simply extend into the layer and will not have the ends of a substantial portion of the CNTs associated with a substantial portion of the fibers. Such association will only occur on the surface of the layer and not throughout the layer as in the present invention.

According to another embodiment, the preparation of the CNT-Containing Layer including preparation of the catalyst support structure coupled with growth of the CNTs is performed in-line. In-line apparatus are known and can be envisioned by those of skill in the art.

### Optional Supporting Layer

In one embodiment, the present invention can utilize more than one layer, such as a dual layer structure, wherein the top layer is formed on top of or attached to a further supporting layer.

### Fibers of the Optional Supporting Layer

As an example, the dual layer structure according to one aspect of the present invention may incorporate a wet-laid paper-like supporting layer such as that described in U.S. patent application Ser. No. 12/076,758 filed by common assignee on Mar. 21, 2008. It is upon this supporting layer that the above-described fibers are wet-laid along with the catalyst for CNT growth, for instance in a paper machine. This thus catalyst-loaded dual layer structure is exposed to CNT precursor gases in a CVD environment for the in situ growth of CNTs as described in more detail below.

The optional supporting layer adds additional integrity to the CNT-Containing Layer such that the combined layers better sustain the temperatures required to support the catalyst during the synthesis of carbon nanotubes, and subsequently function as a practical product, e.g., a media such as a filter media. Thus, the first top layer (CNT-Containing Layer) carries and retains the catalyst particles, and the second supporting layer lends additional support for the catalyst containing layer.

Preferably, the optional support layer provides additional physical properties to the dual layer structure when functioning in excess of 600° C., and thereafter in practical applications, e.g., as a media, such as a filter media.

The optional support layer may include the same fibers as the fibers of the CNT-Containing Layer, described above. In addition, in one embodiment, the optional support layer may also contain bulk refractory fibers (as described herein) having an average diameter of about 1 to 4 microns. The bulk refractory fibers, formed by a bulk forming process, e.g., a blowing process, can provide improved interlocked, high temperature resistant fibers that can form a strong support layer.

To provide even greater strength to the optional support layer, so that the combined dual layer structure/substrate will have increased physical properties during the catalytic vapor depositions reaction and during subsequent use as a product, e.g., a media, such as a filter media, the optional support may also contain microglass fibers, in amounts of about 1% to 12%, especially about 3% to 8%. Preferably, the microglass fibers have an average diameter of about 0.1 to 1.5 microns. The microglass fibers preferably have a softening point of about 540° C. and satisfactorily perform as a heat resistant inorganic binder. Thus, when the second support layer is subjected to temperatures in excess of 600° C. in a chemical vapor deposition chamber, the microglass fibers will soften and adhere the fibers and/or the catalyst supporting structures together, thus, providing improved physical properties to the dual layer structure.

Further, since refractory fibers are expensive, the optional support layer may contain chopped E-glass fibers. Glass fibers suitable for use in the media of the invention include fibers formed from E-glass, A-glass, C-glass, D-glass, R-glass, S-glass, or E-glass derivatives. Such glass fibers are known in the art. The term “E-glass derivatives” refers to glass compositions containing minor amounts of fluorine and/or boron, typically less than about 1 wt. % fluorine and less than about 5 wt. % boron, although desirably free of fluorine and boron. Preferably, the glass fibers have an average diameter of about 5 to 11 microns. In an embodiment, a preferred glass fiber is the E-glass fiber. Useful fibers may be high temperature resistant glass fibers, having controlled, chopped lengths. These fibers can intertwine in among the bulk refractory fibers, and bulk-up the optional second support layer to give desired configurations of the optional support layer but at reduced costs.

As noted above, the second support layer may have the same fibers as the CNT-Containing Layer but in addition may have bulk refractory fibers and, optionally, chopped E-glass fibers. The support layer is not intended to carry any catalyst and, as described below, in one embodiment, efforts are provided to avoid catalyst particles from penetrating into the second support layer.

The bulk refractory fibers, as with all bulk fibers, are made by a melt blowing or spinning and vary considerably in length, depending upon the particular melt blowing or spinning process, but are readily controllable in the general diameter thereof. Since one purpose of the bulk refractory fibers is to strengthen the support layer, substantial intertwining of the fibers is preferred. To achieve a higher degree of intertwining, in a wet laying process, as described below, the average diameter of the bulk refractory fibers should be between about 1 and 5 microns, especially about 1 to 4 microns, although for other purposes, the diameters could be up to about 15 or 20 microns.

While a wide variety of refractory fibers may be used, it is particularly desirable to use ceramic fibers, especially alumina silica fibers, since these fibers provide high strength, are high temperature resistant and intertwine well. Particularly, this is true when the ceramic fibers have an average diameter of about 1 to 4 microns and an average length of about 0.1 to 0.5 inches.

The chopped E-glass fibers, being chopped fibers, have more specific lengths, and are useful for intertwining in and among the refractory fibers to bulk-up the refractory fibers and contribute to a strong second support layer.

As noted above, while the quartz, refractory and E-glass fibers provide the matrix to form the support layer, additional mechanical strength may be imparted. Therefore, the second support layer may be further strengthened by the use of glass microfibers therein. Also, as briefly noted above, when subjected to temperatures of about 1000° F. (538° C.) or higher, the glass microfibers soften and begin to adhere the fibers to one another. Further, the microglass fibers are preferably of very small diameters so that the softening and adhering of the mixture of fiber will readily take place at temperatures near or above 1000° F. (538° C.), even for short periods of time. Accordingly, it is preferred that the microglass fibers have an average diameter of about 0.1 to 5 microns, although fibers greater than this diameter could be used for other purposes, e.g., up to about 10 or 15 microns. These diameters are readily obtained by conventional melt blowing processes for producing the microglass fibers.

The percentages of the various fibers in the layer can vary considerably, but it is preferred that the percent by weight of refractory fibers is about 10 to 40%, the percentage by weight of E-glass fibers is about 15 to 50% by weight, the percentage of quartz fibers is about 15 to 50% by weight, and the percentage by weight of microglass fibers is about 1 to 15%.

As mentioned above, the particles of the catalyst are preferably retained in the CNT-Containing Layer. Thus, all layers preferably have a very small mean pore size, particularly a mean pore size between about 0.5 and 5 microns. This will prevent the small catalytic particles from substantially departing the CNT-Containing Layer and, for instance, prevent the particles from substantially penetrating into the optional support layer. This is particularly true when the mean pore size of the layers is about 1 micron. Further, in this regard, it preferred that the largest continuous pore size (from one side of the layer to the other front-to-back) is about 25 microns.

In different embodiments, either one optional supporting layer, or multiple supporting layers may be used.

It is preferred that the optional support layer have certain physical properties in order to be processed or otherwise heated to temperatures suitable for chemical vapor deposition reactions, especially temperatures in excess of 1200° F. (649° C.) for producing CNTs. To this end, the optional supporting layer preferably has a longitudinal tensile strength (in the machine direction as being processed and is explained below) of at least 750 grams per inch and a tensile strength of up to about 5000 grams per inch are quite good. Somewhat similarly, longitudinal stiffness of the layer should be at least 500 milligrams and up to 1500 milligrams, after the layer is subjected to a temperature of about 1200° F. (649° C.) for 2 hours.

### Optional Binder

An organic binder may optionally be included in the optional support layer. This will allow for optionally binding the optional support layer more tightly together, especially during processing. In addition, since the optional support layer may be present during the catalytic chemical vapor deposition reactions wherein the CNTs are produced, there are preferably few organic impurities therein at the time of reaction. Accordingly, the optional support layer should have a loss on ignition in a muffle furnace at 1000° F. (538° C.) of no more than 15% and typically about 7% or less. In other words, when a binder is used it is preferred that the binder be substantially burned off so as to not contaminate the layer during catalytic activity. For this reason a relatively fugitive binder, such as an acrylic organic binder, is preferred. However, the binder may be chosen from any one or more of conventional polymeric latex binders used in the paper-making arts, such as olefins and vinyls.

### Properties of the Inventive Media

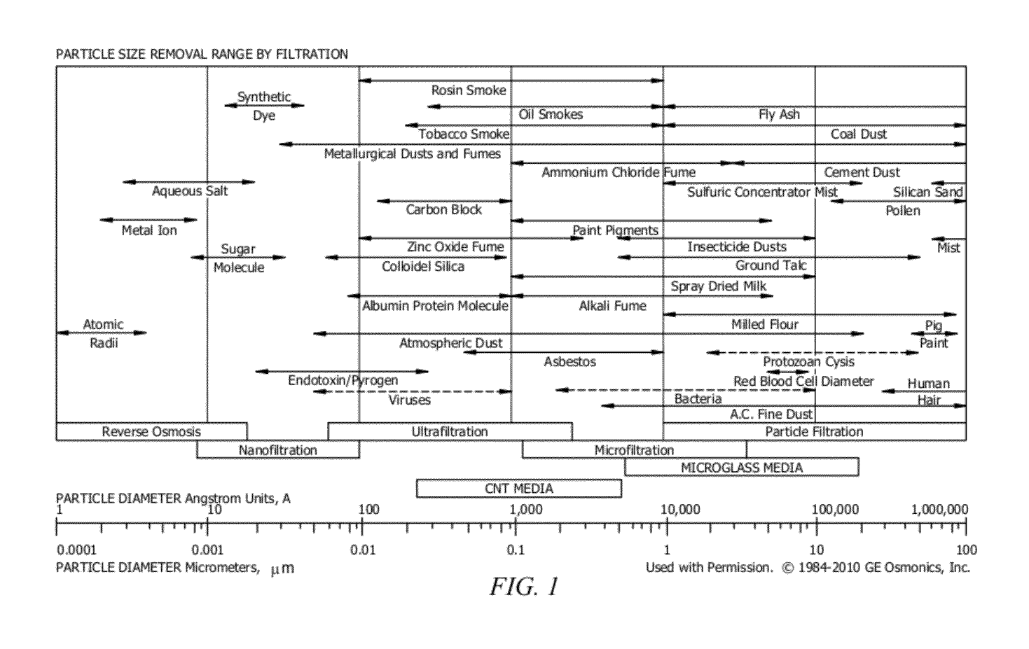

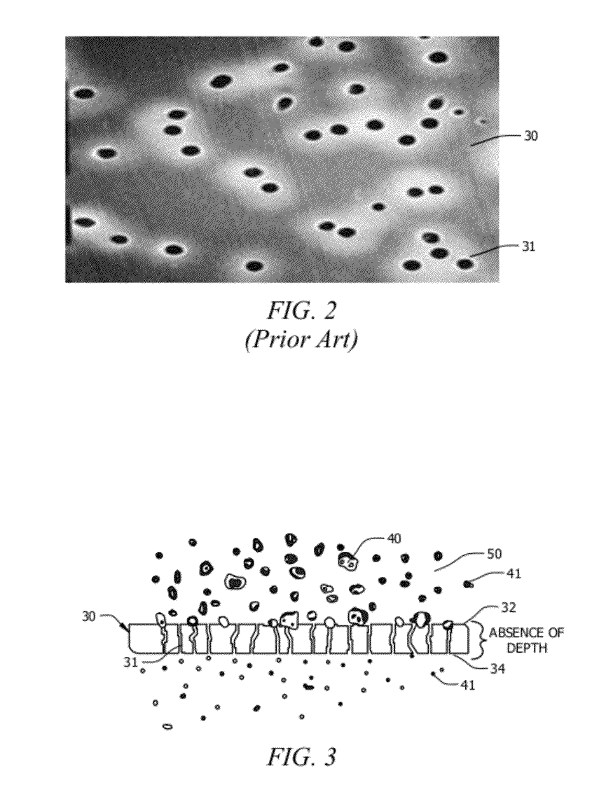

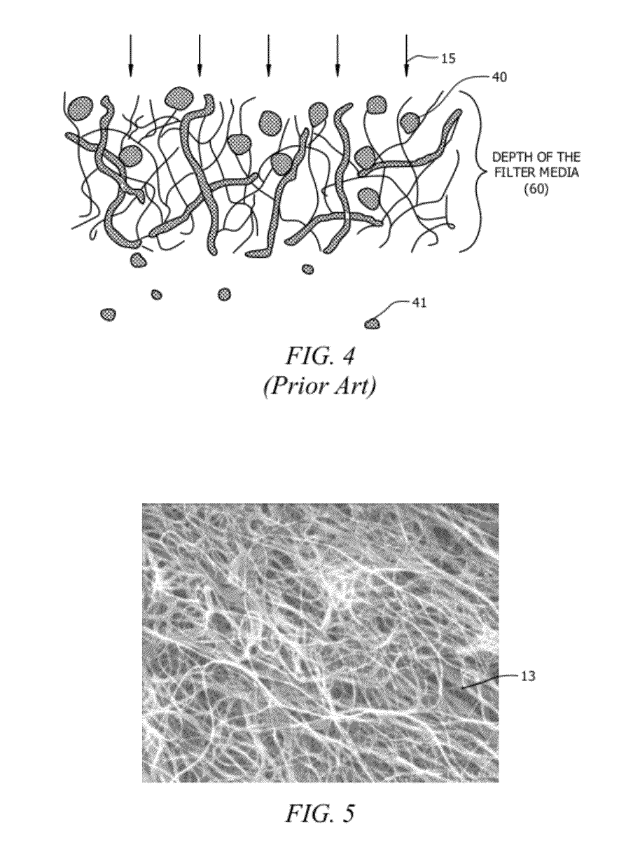

The present inventive media made as described herein desirably has optimal properties for particle size removal and/or dirt load capacity. For instance, the media can be tailored so as to exclude different particle sizes, such as greater than 10000, 9000, 8000, 7000, 6000, 5000, 4000, 3000, 2000, 1000, 900, 800, 700, 600, 500, 400, 300, 200, 100 Angstroms. Reference is also made again to FIG. 1, wherein an example of different particle diameters in relation to those particle diameters (particularly those in the range of about 1 to 200 nanometers) for which the CNT media according to one aspect of the present invention are designed to filter is shown. However, it can be appreciated that particle diameters both higher and lower than that displayed in FIG. 1 can be achieved by modifying different properties of the present CNT media.

Additionally, the dirt load capacity of the present media can be tailored to suit different needs of consumers. It is understood that the higher the dirt load capacity, the longer the ultimate life of the media. Illustratively, the dirt load capacity of the CNT media according to one aspect of the present invention is tested by subjecting a 90 mm flat disk of the CNT media, having a diameter of 0.068 sq. ft. at a flow of 0.06 micron latex beads (Concentration—2.5 ml in 1800 ml H₂O). The dirt loading capacity is then evaluated by measuring the amount of time that it takes to reduce the flow rate by 50%. According to the present invention, this flow rate can be reduced by half in greater than 1, 2, 3, 4, 5, 6, 7, 8, 9, 10, 11, 12, 13, 14, 15, 16, 17, 18, 19 or 20 minutes. Preferably, the flow rate is reduced by half within the range of 5-20, 8-17, or 10-15 minutes. However, it can be appreciated that higher halving times for flow rates, such as 100, 90, 80, 70, 60, 50, 40, or 30 minutes are envisioned herein.

In general, it is contemplated that the CNT in the media according to one aspect of the present invention have a high surface area in the range of about 200-1000 m²/gm, preferably 200-1000 m²/gm, including a relatively high electrical conductivity and heat conductivity. Although it is contemplated herein that the CNT media according to one aspect of the present invention are useful for media that target virus-sized particle removal efficiency, it is also contemplated that the CNT media can also be used as a membrane or an electrode in a fuel cell. It is further contemplated that the CNT media would be useful in desalination of water, gas diffusion, for use as a construction composite (given the known strength characteristics of CNTs), and the like.

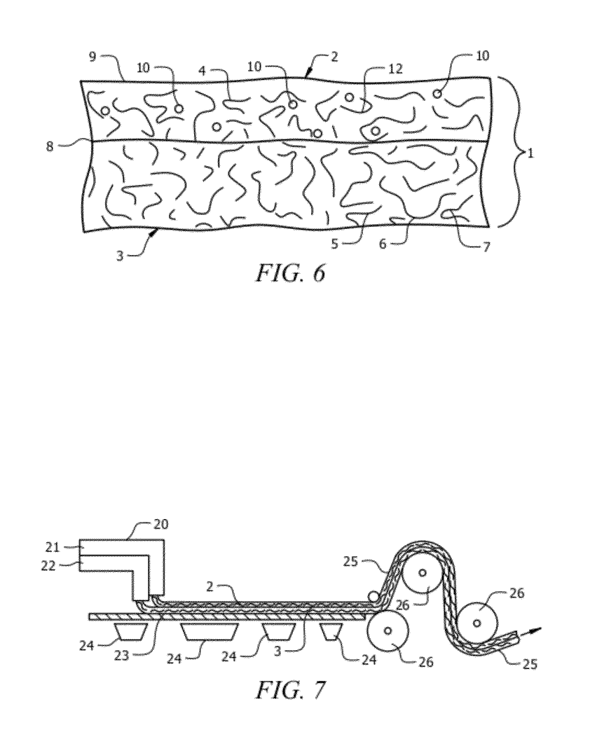

Referring to FIG. 6, in one embodiment, the dual layer structure or substrate 1 according to the present invention has a catalyst support layer 2 (or “top layer”, which forms the CNT-Containing Layer described in detail below) and an optional supporting layer 3. The top layer 2, which will contain the catalyst 10, may include glass fibers 4 (such as staple quartz fibers, chop strand DE fibers) with an average diameter of between about 0.1 and 10 microns, and optionally, ceramic refractory fibers 12 (such as ceramic refractory HP-HAS, high purity silica fibers) with an average diameter of between about 0.1 to 4 microns. As shown for instance in FIG. 9, the top layer 2 includes glass fibers 4 and ceramic refractory fibers 12, wherein the diameter of the glass fibers 4 is greater than the diameter of the ceramic refractory fibers 12. Turning again to FIG. 6, the optional supporting layer 3 may include the same fibers as the top layer 2 and, in addition, bulk refractory fibers 6 having an average diameter of about 1 to 4 microns and, optionally, chopped E-glass fibers 7, as well as microglass fibers 5.

The top layer 2 joins the supporting layer 3 at a juncture or interface 8 where the fibers of the top layer 2 and the fibers of the supporting layer 3 intermingle, to a certain extent, as described more fully hereinafter.

The method of producing a dual layer structure/material is diagrammatically illustrated in FIG. 7, which is a highly idealized side view of a wet laying machine. As shown in FIG. 7, the top layer 2 and the supporting layer 3 are laid from a dual head box 20 having a first flow path 21 and a second flow path 22 for depositing the top layer 2 and the supporting layer 3, respectively, on a formacious traveling device, such as a screen, 23, fitted with suction devices 24. Thus, the method comprises wet laying the fibers of the supporting layer 3 onto the formacious screen 23 to form the wet-laid supporting layer 3, and then wet laying the fibers of the top layer 2 onto the wet-laid supporting layer 3 at a time in the forming of the supporting layer 3 such that the fibers of the top layer 2 can partially intermingle (intertwine) with the fibers of the supporting layer 3, as shown in FIG. 6 by the wavy line at juncture 8.

As can be seen from FIG. 7, the supporting layer 3 is first laid from the second flow path 22 onto the formacious screen device 23, and, thereafter, after an appropriate delayed time, e.g., 1 second or less, the top layer 2 is laid from the first flow path 21 onto the top of the supporting layer 3. That delay in time is sufficient such that the supporting layer 3 begins to form by action of being dewatered by suction devices 24. But before that supporting layer 3 is consolidated, the fibers of the top layer 2 are laid thereon. Since the suction devices 24 will also pull water from the top layer 2, some of the fibers of the top layer will penetrate into the juncture 8 (see FIG. 6) and therefore bind the two layers together. Thus, the top layer 2 is laid onto the wet-laid supporting layer 3 at a time of the forming of the supporting layer 3 such as the fibers of the top layer 2 can intermingle and intertwine with the fibers of the supporting layer 3 to form a consolidated wet-laid substrate 25 (FIG. 7).

That consolidated wet-laid substrate 25 is dewatered and dried sufficiently to form the dual layer structure or substrate 1 (see FIG. 6) in such a manner that the top layer 2 and supporting layer 3 are not easily separable from one another. This is achieved by passing the consolidated wet substrate 25 over a series of drying cans 26 where the consolidated wet-laid substrate 25 is dried to a low moisture content, e.g. about 10% or less and so as to have the properties described above. While not shown in the drawings, a binder may be sprayed onto the top layer 2 by a plurality of nozzles (not shown) spaced across the width of the layers, the binder pulled through the layers by a conventional felt vacuum box (not shown). The binder may be useful in some applications for strengthening the layers during processing, particularly during drying. The flows through first flow path 21 and second flow path 22 of the top layer 2 and supporting layer 3, respectively are preferably such that the consolidated substrate 25 when dried has a weight of about 5 to 40 lbs per 1000 sq. ft.

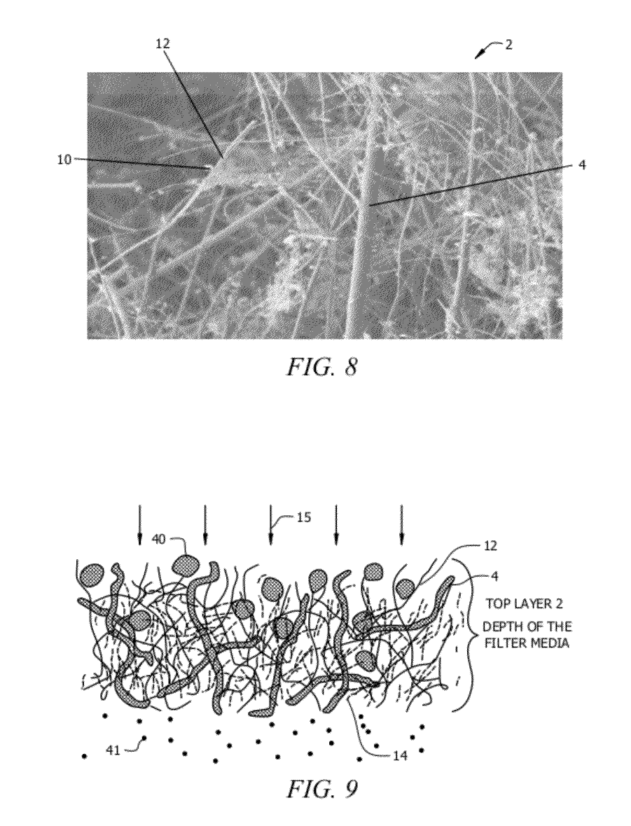

To form the catalyst 10 into the substrate l5, the catalyst 10 is applied to a top portion 9 (see FIG. 6) in a dispersed form of finely divided particulate solid catalyst, e.g., by spraying the catalyst dispersed in a liquid either during or after forming the consolidated substrate 25. Alternatively, the catalyst 10 can be formed in situ in top layer 2 by dispersing a precursor of the catalyst in the top layer 2 and then supplying to that precursor a further component to cause the precursor to form catalytic particles in the top layer 2. Alternatively, catalyst particles may be dispersed in the head box so as to flow with the top layer 2 from flow path 21. This latter dispersion arrangement is the preferred embodiment. In any event, as shown in FIG. 8, the catalyst particles 10 are preferably uniformly dispersed in the top layer 2 and by reason of the pore sizes, as described above, preferably little or none of the catalyst particles penetrate into the supporting layer 3. FIG. 8 depicts a SEM of a top layer 2 of the present invention prior to CNT growth.

The thickness of the top layer 2 can vary as desired, but with a very thin top layer, the chemical vapor disposition (CVD) catalytic reaction, e.g., in forming CNTs, can take place such that the CNTs essentially generate from the top portion 9 of the top layer 2 and project upwardly therefrom. Since the catalyst particles can be spaced apart, by the present fiber arrangement of the present invention, by a mere few microns or less, the CNTs can be generated at distances apart of, likewise, a few microns or less. That results in the pore sizes of the generated CNTs, in filter media form, of likewise being only a few microns or less. Such very low pore size of the generated CNTs can provide a filter media that will filter exceedingly small particles, even virus particles. However, for other or slightly different purposes, the weight ratio of the top layer 2 to the support layer 3 (without catalyst) may vary from 1:20 to 20:1, but more usually 1:10 to 10:1.

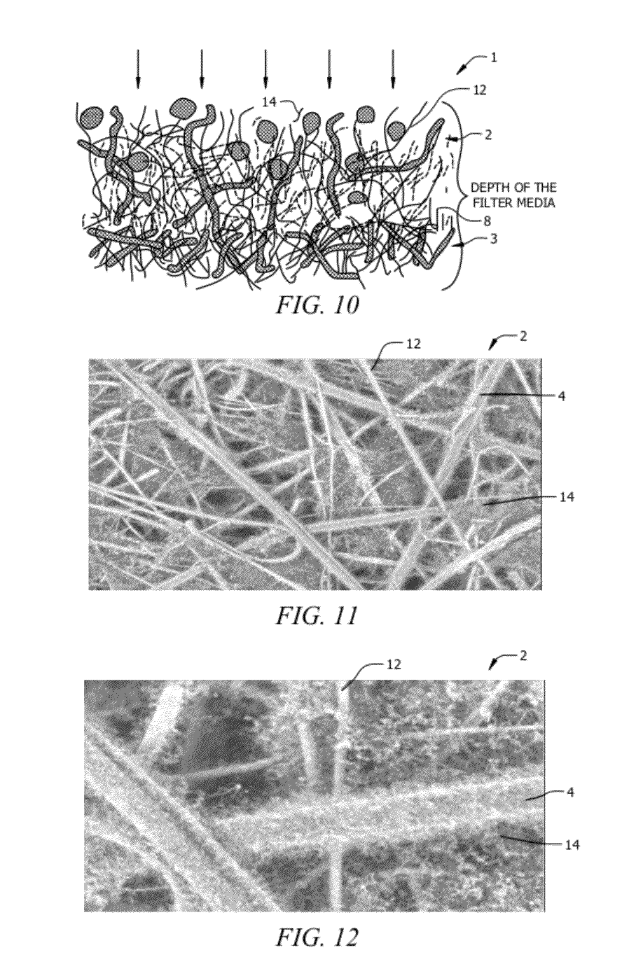

Referring to FIG. 10, in one embodiment, the dual layer substrate 1 according to the present invention includes the top layer 2 and the supporting layer 3 after in situ growth of the CNTs 14 within the top layer 2 is illustrated. As shown herein, the fibers of both of the top layer 2 and the supporting layer 3 intermingle at the juncture 8. FIGS. 11 and 12 show SEM images (FIG. 12 having an increased magnification over FIG. 11) of an actual top layer 2 of the present invention showing a media made of glass fibers 4 and ceramic refractory fibers 12, wherein the CNTs 14 have been grown in situ on the fibers of the media.

### EXAMPLES

The embodiments having been generally described, the following examples are given as particular embodiments of the invention and to demonstrate the practice and advantages thereof. It is understood that the examples are given by way of illustration and are not intended to limit the specification or the claims in any manner.

### Example 1

### Forming a Dual Layer Substrate

The machine used in this Example 1 was a conventional rotoformer set for 25.5 inches dry paper width. The machine had a Machine Chest for laying the supporting layer and a Blend Chest for laying the top layer. Both chests had a 1000 gallons (3785.4 liters) capacity. There were ten dryer cans that were normally operated with internal steam pressures of about 60 to 80 psig (about 29.07 to 38.77 kPa) to provide operating temperatures of up to about 300° F. (149° C.). The water extraction suction was usually operated at about 15-20 inches (38.1-50.8 cm) of water vacuum to dewater the slurry when the machine was operated at the usual run speed of about 10 feet (3.05 m) per minute.

In this particular Example 1, a first hydropulper was loaded with 600 gallons (2271.2 liters) of water and 900 ml of sulfuric acid (industrial grade) to lower the pH to about 4.0. This aids in the dispersal of the fibers. Fibers were added to create the supporting layer until there was a consistency of about 0.138%, which was about 15 lbs in this Example 1, and 20% of ceramic refractory fibers (PG 111 commercially available ceramic fiber by Unifrax), 26% chopped strand DE microglass fibers (commercially available from Johns Manville), 47% amorphous silica quartz fibers and 7% Code 100 microglass fibers (commercially available from Johns Manville) were added.

Into a second hydropulper, the components of a top layer according to the present invention included 76% quartz fibers, 1% Code 100 microglass fibers and 23% catalyst, as described below, were added to 600 gallons (2271.2 liters) of water, until a consistency of 0.128% was reached, which was about 9.6 lbs. of fibers in this Example 1. No acid was added because it may adversely affect the catalyst, depending on the particular catalyst to be used, and a lower consistency and longer pulping time were used. In this Example 1, about 2 minutes of pulping time was used in the first hydropulper and about 5 minutes in the second hydropulper.

The contents of the first hydropulper were dumped into the Machine Chest, along with another 600 gallons (2271.2 liters) of dilution water and the contents of the second hydropulper were dumped into the Blend Chest, along with another 600 gallons (2271.2 liters) of dilution water.

A catalyst was prepared by dissolving 2.6 kilogram of iron sulfate (catalyst nanoparticles) in 8 liters of water and adding this solution to 16 liters of water containing 1.3 kilogram of aluminum oxide powder (catalyst supporting structure). This suspension was processed in a spray drier to yield ˜3.5 kg of particles substantially less than 10 microns in diameter. The catalyst powder was reduced in a vacuum with flowing ammonia at temperatures ranging from about 500-800° C., preferably from about 600-700° C. Afterwards, the catalyst was added to the Blend Chest at a concentration of about 11 grams catalyst per liter of water. Dispersion of the solids was aided through the use of an ultrasonic dual-frequency reactor (such as that commercially available from Advanced Sonics).

The flow rates of the two chests were 38 gallons/minutes and 37 gallons/minute for the Machine Chest and the Blend Chest, respectively. The machine speed was set at 10 feet/minute and the vacuum was set on the water extractors at about between 15 and 20 inches of water.

The supporting layer was first laid from the Machine Chest onto the former screen, and then with about a 1 second delay, the top layer was laid from the Blend Chest onto the forming supporting layer. This delay caused an intermingling of the fibers at the interface of the two layers, as explained above. The water drained from the forming layers was monitored to insure that the catalyst remains in the layers and does not pass through the forming layers. After the layers were formed, an acrylic latex binder (HYCAR-26106 commercially available from Lubrizol) at a 1.77% consistency was sprayed onto the top layer at an average spray rate of about 9.51 gallons/hour/nozzle, with four nozzles equally distanced across the width of the formed dual layered substrate/sheet. The substrate was then passed over a conventional felt vacuum box operated at about 8 to 15 inches of water to suck the binder through the substrate and produce a substrate with a moisture content of about 70 to 80% moisture and then dried on the ten drier cans at about 300° F. and at a speed of about 10 feet/minute. The thus dried substrate was then collected in rolls. The composition of the dried dual layer substrate (as a whole) was about 10% PG 111 ceramic refractory fibers, 13% DE chopped glass strand fibers, 4% Code 100 microglass fibers, 58% quartz fibers, 11% catalyst and 4% binder. The ratio of the weights of the top layer to the supporting layer was about 1:2.

### Physical Properties

### Before Growth

Thickness—22.5 mils @8 psi
Pressure Drop—47.5 mm H₂O.

### Example 2

### Catalyst Deposition onto the Substrate

Electroless metal deposition reactions are used in industry to deposit metals atop other materials to create a coating. In an electroless reaction, metal nanoparticles are simultaneously nucleated on the target material, and these particles grow to form a continuous coating for most applications. In contrast to electroplating, the reduction of the metal ions in solution is accomplished by the action of a chemical reducing agent. Among the metals that can be deposited using electrochemical means, copper, and nickel are common. For use as a nanotube catalyst, nickel is a suitable metal, and for nanotube growth, a continuous coating is not required. Therefore, an electroless nickel deposition reaction according to one aspect of the present invention can be halted just after the nucleation of nickel nanoparticles on the surface of the target material. It should be noted that as shown here the catalyst was nickel, and has no support particle. The nickel was deposited directly on the fibers, and could have some chemical bond to the fiber. As such, the nanotubes arguably grow distally from the fiber(s).

Typically, a glass surface is prepared for the electroless deposition of nickel by applying onto the surface a sensitizer which acts to deposit a catalyst for the nickel reduction from an electroless nickel plating solution, as described in U.S. Pat. No. 5,380,559. For example, an aqueous solution of stannous chloride (SnCl₂) applied to a glass surface, such as a microscope slide, will coat the surface with Sn²⁺ ions. When this sensitized surface is exposed to a solution of Pd²⁺ ions, an oxidation reduction reaction occurs in which the tin ion is oxidized to Sn⁴⁺ and the palladium ion is reduced to palladium metal (Pd⁰). When this activated surface is subsequently exposed to a solution of Ni²⁺ and a reducing agent, such as sodium hypophosphite, the palladium (Pd⁰) catalyzes the reduction of nickel ion to nickel metal (Ni⁰), which is itself a catalyst for its own reduction.

In the art, electroless deposition typically requires several steps to initiate the nucleation of the nickel nanoparticles. This is commonly performed using several baths, often referred to as sensitizing or activator baths.

A 4×4 inch sheet of a top layer according to one aspect of the present invention, such as a paper made from quartz and Code 100 microglass fibers was immersed in a bath of hot 90% sulfuric acid to remove any organic contaminants and then rinsed with deionized water. Next, the paper was immersed in a sensitizer solution containing tin chloride (SnCl2) and palladium chloride. An example of such a solution includes Cataposit™ PM-957, a commercially available product sold by the Dow Chemical Company, which contains stannous chloride at 500 g/l and palladium chloride at 6.6 g/1 at a pH below 1. The immersion of the paper in this bath left easily reduced ions on the surfaces of the paper, which were reduced to form nanoparticles.

This step was followed by a rinse step and immersion in a 2% palladium chloride solution, adjusted to pH 1 with HCl, to further activate the fibers.

The final step was immersion in a bath containing the nickel ions. Multiple bath chemistries are known for electroless deposition. For the quartz fiber paper, a nickel chloride electroless solution was prepared containing 30 g/liter of nickel chloride hexahydrate, 10 g/liter of sodium hypophosphite (NaH₂PO₂), and 8 g/liter of sodium acetate. Sodium hypophosphite is a reducing agent, and reduces the nickel ion to elemental nickel, preferentially at the surfaces where the fibers are activated with the palladium chloride.

Although typically used at an elevated temperature, the bath was used with the paper at room temperature, to slow the growth rate of the nickel nanoparticles, thereby maximizing the yield of small nanoparticles of nickel on the quartz fibers. These nickel nanoparticles are catalytic to the growth of CNTs using the CVD process described above.

### Example 3

### Growth of CNTs

For each synthetic run, a sheet of the dual layer catalyzed media was laid onto a molybdenum boat and inserted into a 2 inch tubular quartz CVD reactor. The reactor chamber was then evacuated to about 10⁻² torr, following which the temperature of the chamber was raised to about 600° C. Gaseous ammonia was introduced into the chamber at a flow rate of 80 sccm and maintained for 10 minutes, following which acetylene at a flow rate of 20 sccm was introduced to initiate CNT growth. The total gas pressure within the reaction chamber was maintained at a fixed value of 1 torr, (although pressures from 0.6 torr to 760 torr may been used depending on desired morphology for the CNTs). The reaction time was also controlled to 30 minutes to regulate the length of the CNTs grown.

### Example 4

### CNT Media

This Example describes the preparation of CNT wetlaid depth media. The CNT laden media in its bare condition may be difficult to handle as it has some loose CNT' s on the surface which dust off and stick to the hands or any other handling equipment. During a filter media testing, this CNT dust, if not restricted by a barrier, has the potential to go downstream in a test and affect the filtration efficiencies. With the above potential drawbacks, the bare CNT wet-laid depth media may be optionally encompassed or laminated between two layers, typically activated carbon loaded polypropylene melt-blown media. This activated carbon loaded meltblown media had the following physical properties:
Thickness—7 mils @8 psi
Pressure drop—0.1 mm H₂O.

The lamination or gluing of the meltblown media can be done in laboratory for flat sheets in sizes ranging from 6×6 inch to 12×12 inch. However, depending on the type of sample used for CNT growth, flat sheet or roll form, as explained above, a commercial laminator such as a spray laminator can be used for laminating the two meltblown layers to the CNT media. But, this lamination is not restricted to meltblown polypropylene layers. Depending on the final design (e.g., of a media, such as a filter media) by a customer or the final application, the meltblown polypropylene layers can be substituted by microglass filter paper, polyester or other polymer based layers or potentially by a membrane such as ePTFE, stretched polyethylene or other commercially available membrane used in high efficiency filtration such a virus removal in drinking water, desalination membranes, etc.

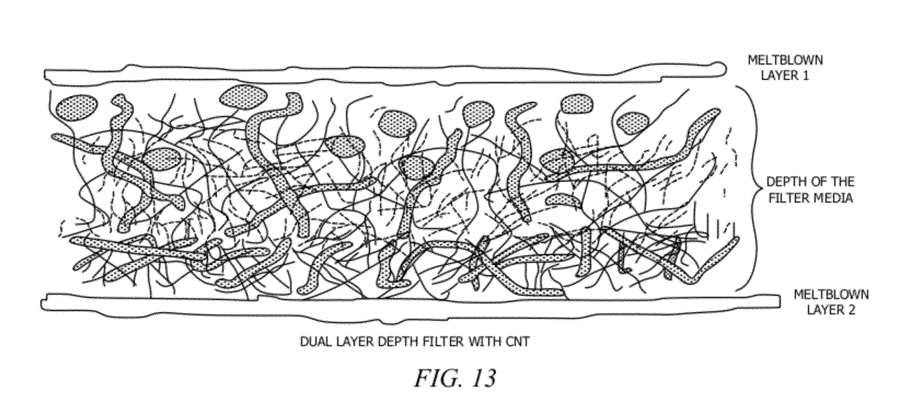

The basic process calls for glue which can be sprayed on the bare CNT media and two layers/papers that can sandwich the CNT media between them, hence creating 3 layers in the product design as shown in FIG. 13.

Samples of CNT media according to one aspect of the present invention were prepared as described above for Examples 1-4, having the physical properties as shown below:

### Physical Properties

Thickness—58 mils @8 psi
% Carbon—40%
Mean Pore Size—as seen in Table 1 below.

TABLE 1

| | Pore Size in μm | | |
|---|---|---|---|
| Sample No. | Min | MFP | Max |
| 1 | 0.14757 | 0.30425 | 0.41109 |
| 2 | 0.18007 | 0.30425 | 0.36220 |
| 3 | 0.14242 | 0.23060 | 0.35218 |
| 4 | 0.14716 | 0.23060 | 0.35740 |
| 5 | 0.14060 | 0.24787 | 0.36805 |
| 6 | 0.11940 | 0.31906 | 0.35737 |
| 7 | 0.14500 | 0.36774 | 0.68974 |

TABLE 2
PERFORMANCE OF THE CNT WETLAID DEPTH MEDIA
Turbidity Analysis

| | | Tur- | Tur- | Pressure | | |
|---|---|---|---|---|---|---|
| | | bidity | bidity | drop | Flow | |
| No. | Sample | 1 FTU | 2 FTU | psi | ml/min | Notes |
| Con- | Lydall 9355 | 43 | 44 | — | 50 | |
| trol | Microglass grade | | | | | |
| 1 | Pall 0.1 | 2 | 0 | — | 50 | prewet |
| | micron capsule | | | | | |
| 2 | Millipore Omni- | 13 | 15 | — | 50 | hydro- |
| | pore 0.1 90 mm | | | | | philic |
| 3 | GE 0.1 | 31 | 39 | — | 75 | prewet |
| | micron capsule | | | | | |
| 4 | CNT MEDIA | 1 | 0 | 18 | 50 | |
| 5 | CNT MEDIA | 0 | 0 | 25 | 50 | |
| 7 | CNT MEDIA | 0 | 1 | 25 | 50 | |
| 8 | CNT MEDIA | 0 | 0 | 20 | 50 | |
| 9 | CNT MEDIA | 1 | 1 | 18 | 50 | |
| 10 | CNT MEDIA | 1 | 1 | 23 | 50 | |
| 11 | CNT MEDIA | 3 | 1 | 23 | 50 | |
| 12 | CNT MEDIA | 1 | 0 | 23 | 50 | |
| 13 | CNT MEDIA | 1 | 3 | 20 | 50 | |

Latex microspheres—0.06 micron
Concentration—2.5 ml in 1800 ml H2O
Initial Turbidity—43 FTU
Turbidity 1—First 25 ml of filtrate
Turbidity 2—25 ml of filtrate after 1 minute
Area—90 mm dia flat sheet, 0.068 sq.ft.

As seen above in Table 2, the Turbidity Analysis data, based on ASTM F795-88, indicates high initial filtration efficiency for a contaminant of 0.06 micron beads, latex microspheres. The data in Table 2 also includes competitive membrane-based filter modules from GE and Pall, as well as a flat disc membrane from Millipore. Also included below in Table 3 is Initial Efficiency of the CNT Media. The data set includes a Millipore 0.22 micron membrane as a control.

TABLE 3
Test Data

| | |
|---|---|
| Test Method: | ASTM F795 Initial Efficiency |
| Sample Identification: | Multiple Samples |
| Sample Description: | 90 mm Flat Sheet |
| Test Housing: | 90 mm Dual Cone - “Deep” Housing |
| Fluid: | Water |
| Test Flow Rate: | 0.5 gpm/ft 2 (102 cc/min) |
| Temperature: | Ambient |
| Contaminant: | Monodispersed Latex Beads |
| Particle Sizes: | 0.19 um Latex Beads (0.16-0.35 um) |
| Injector Concentration: | 0.2 mL Slurry/1 Ltr |
| Sample Points: | Initial |
| Inject Flow Rate: | 6 cc/min |
| Sensor Pump Rate: | 100 cc/min |
| Sensor | MC-100 S/N: M1029 Next Cal: January 2009 |
| Particle Counter | HR8000A S/N: 95020015 Next Cal: January 2009 |

| | MC-100 - Millivolts | | |
|---|---|---|---|
| | 173.4/S1 | 7640.0/S2 | |
| | 8 × 15 sec Differential | | |
| NetSummary | counts @ 100 cc/min | | |
| Microns | | 0.16 | 0.35 |
| Lydall-1 | Upstream | 460096 | 4700 |
| 9867-13 | Downstream | 2421 | −117 |
| Initial-net | Efficiency | 99.5 | 102.5 |
| Lydall-2 | Upstream | 464551 | 5198 |
| 9867-16 | Downstream | −10853 | −784 |
| Initial-net | Efficiency | 102.3 | 115.1 |
| Lydall-3 | Upstream | 461919 | 5495 |
| 9752-1 | Downstream | −2147 | −62 |
| Initial-net | Efficiency | 100.5 | 101.1 |
| Lydall-4 | Upstream | 475476 | 5609 |
| 9867-16 | Downstream | 6079 | −274 |
| Initial-net | Efficiency | 98.7 | 104.9 |
| Lydall-5 | Upstream | 459518 | 5009 |
| 9867-9 | Downstream | 15587 | −117 |
| Initial-net | Efficiency | 96.6 | 102.3 |
| Lydall-6 | Upstream | 300201 | 2972 |
| 9867-15 | Downstream | −940 | −163 |
| Initial-net | Efficiency | 100.3 | 105.5 |
| Millipore 0.22 um (Control) | Upstream | 282422 | 2105 |
| 9867-26 | Downstream | 1603 | −35 |
| Initial-net | Efficiency | 99.4 | 101.7 |
| Millipore 0.22 um (Control) | Upstream | 281020 | 2036 |
| 9867-26 | Downstream | 1729 | −9 |
| Initial-net | Efficiency | 99.4 | 100.4 |

As shown in Table 4, although media and test variability impact the data, the CNT medias made according to one aspect of the present invention, Lydall 1-6, performed at least as well, if not better than the Control.

To further exemplify the advantage of the wet-laid depth media (CNT media) according to one aspect of the present invention over a conventional membrane, a Dirt Load Capacity study was done. The data is shown below in Table 4.

TABLE 4
Single Pass Dirt Loading Capacity Analysis

| | | Turbidity | | Pressure | | Flow | |
|---|---|---|---|---|---|---|---|
| | Time | FTU | | drop Psi | | ml/min | |
| Sample Control | min | Initial | Final | Initial | Final | Initial | Final |
| Millipore 0.1 micron 1 | 4:00 | 14 | 0 | 0 | 18 | 50 | 25 |
| 90 mm Omnipore | | | | | | | |
| Millipore 0.1 micron 2 | 6:45 | 29 | 20 | 2 | 21 | 50 | 25 |
| 90 mm Omnipore | | | | | | | |
| Millipore 0.1 micron 3 | 7:15 | 40 | 25 | 2 | 20 | 50 | 25 |
| 90 mm Omnipore | | | | | | | |
| Average | 6:00 | 27.67 | 15.00 | 1.33 | 19.67 | 50.00 | 25.00 |
| CNT MEDIA 1 | 13:00 | 3 | 0 | 25 | 29 | 50 | 25 |
| 90 mm Disc | | | | | | | |
| CNT MEDIA 2 | 10:53 | 4 | 1 | 30 | 33 | 50 | 25 |
| 90 mm Disc | | | | | | | |
| CNT MEDIA 3 | 11:00 | 1 | 3 | 20 | 30 | 50 | 25 |
| 90 mm Disc | | | | | | | |
| Average | 11:37 | 2.67 | 1.33 | 25.00 | 30.67 | 50.00 | 25.00 |

Latex microspheres—0.06 micron
Concentration—2.5 ml in 1800 ml H₂O
Initial Turbidity—43 FTU
Turbidity 1—First 25 ml of filtrate
Turbidity 2—25 ml of filtrate after flow rate is half of the initial flow rate
Start—0:00 minutes, Flow Rate—50 ml/min
End—Flow rate 25 ml/min
Area—90 mm dia flat sheet, 0.068 sq.ft.

From the data above the CNT Media according to one aspect of the present invention had almost double the life of a 0.1 micron membrane (6 min vs 11:37 min). Total slurry filtered was almost double as that of the membrane.

Each of the CNT Media samples were 93.8% efficient at the start and 97% efficient towards the end of the test which is far better than the 0.1 micron membrane samples which were 37% efficient at the start and 65% efficient at end. Since the Omnipore membrane is a hydrophilic membrane, it has a low differential pressure drop at the beginning of the test, but as the dirt of 0.06 micron beads build up, the pressure drop rapidly rises to an average of 20 psi and the flow rate is halved from 50 ml/min to 25 ml/min in half the time as compared to the CNT media according to one aspect of the present invention. The CNT Media has a high starting pressure drop of 25 psi due to its nature of construction from CNTs, but the increase in pressure to halve the flow rate and the time taken to increase the pressure drop leads to high dirt loading capacity in terms of the amount of solution filtered.

### MS2 Virus Removal Testing

Various samples were prepared as shown below in Table 5. For each of the samples below, a CNT media including the dual layered structure described above for Examples 1-4 was used in a layered fashion. In other words, the sample labeled Layer #1 included a single dual layered structure, Layer #2 included 2 dual layered structures stacked together, and Layer #3 had 3 dual layered structures stacked together as known by those of ordinary skill in the art. As shown in Table 5, each test set was conducted on 3 round disks of CNT containing media, each of the disks having a diameter of 47 mm. Each of the samples were tested for virus removal at a flow rate of 50 ml/minute. MS2 coliphage (0.02 micron) was used as the challenge organism.

### Influent Concentration of 10e6 Plaque Forming Unit/mL DI Water

TABLE 5

| | MS2 3-Layer Test Constructions | | | |
|---|---|---|---|---|
| Test # | Layer #1 | Layer #2 | Layer #3 | Comments |
| 1 | 13P-NL-2 | 13P-NL-1 | 13P-NL-3 | |
| 60 nm Eff | 92.2 | 96.4 | 98.1 | high NL |
| ΔP | <3.0 | 3.0 | 3.5 | efficiency |
| MFP | 0.38 | 0.4 | 0.39 | increasing |
| Modal Pore | 0.24 | 0.24 | 0.24 | efficiency |
| Bubble Pt | 5.1 | 6.66 | 5.89 | |
| % Carbon | 50.4 | 49.7 | 50.4 | |
| 2 | 12P-NL-5 | 12P-NL-4 | 12P-NL-1 | |
| 60 nm Eff | 100.0 | 100.0 | 98.1 | highest NL |
| ΔP | 7.0 | 5.0 | 8.0 | efficiency |
| MFP | 0.20 | 0.17 | 0.28 | decreasing |
| Modal Pore | 0.20 | 0.18 | 0.22 | efficiency |
| Bubble Pt | 3.17 | 2.95 | 4.58 | |
| % Carbon | 48.4 | 48.2 | 47.9 | |
| 3 | 12P-NL-3 | 12P-NL-2 | 13P-NL-4 | |
| 60 nm Eff | 98.0 | 98.0 | 89.3 | lowest NL |
| ΔP | 5.0 | 7.0 | <3.0 | efficiency |
| MFP | 0.22 | 0.23 | 0.41 | decreasing |
| Modal Pore | 0.20 | 0.21 | 0.24 | efficiency |
| Bubble Pt | 3.34 | 3.11 | 5.16 | |
| % Carbon | 47.5 | 47.5 | 50.9 | |
| 4 | 12P-121509 | 12P-121809 | 12P-121109 | |
| 60 nm Eff | 95.3 | 91.7 | 90.4 | highest LDL |
| ΔP | 8.0 | 5.0 | 6.0 | efficiency |
| MFP | 0.40 | 0.43 | 0.38 | decreasing |
| Modal Pore | 0.22 | 0.23 | 0.23 | efficiency |
| Bubble Pt | 7.09 | 7.26 | 15.88 | |
| % Carbon | 59.4 | 56.9 | 53.4 | |
| 5 | 12P-121709 | 12P-121409 | 12P-10410 | |
| 60 nm Eff | 75.6 | 75.6 | 73.9 | lowest LDL |
| ΔP | <3.0 | <3.0 | <3.0 | efficiency |
| MFP | 0.70 | 0.79 | 0.81 | flat |
| Modal Pore | 0.26 | 0.28 | 0.28 | efficiency |
| Bubble Pt | 5.45 | 6.84 | 6.47 | |
| % Carbon | 50.4 | 54.1 | 51.1 | |

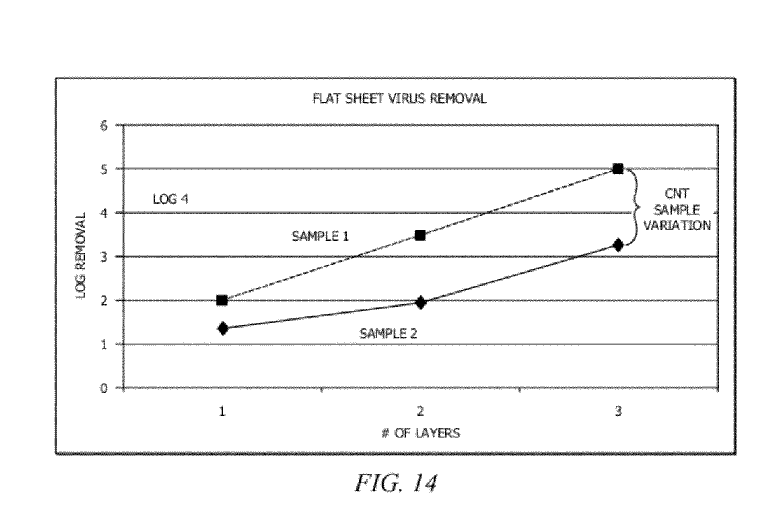

As shown in Table 6 and FIG. 14, for each of the samples, a target of 4 log reduction (i.e., 99.99% reduction) was attempted to be achieved.

TABLE 6
MS2 Flat Sheet Log Reduction

| Sample # | Layer #1 | Layer #2 | Layer #3 |
|---|---|---|---|
| 1 | 1.97 | 3.48 | 5.01 |
| 2 | 1.36 | 1.94 | 3.26 |

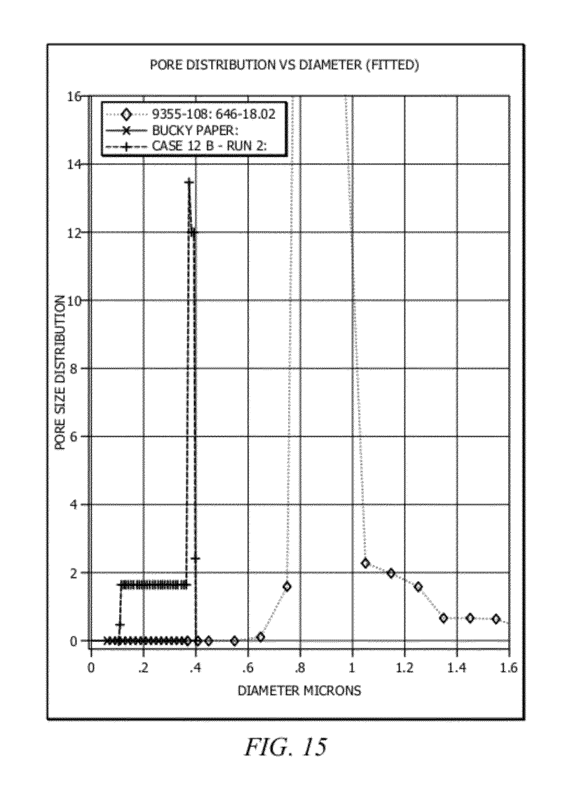

FIG. 15 is a graph showing Mean Flow Pore Size analysis by Capillary Flow Porometry of a sample according to an aspect of the present invention as compared to known media.

In an attempt to replicate flat sheet MS2 removal in cartridge form, 0.83 sq. ft. of media wound in 10″ O-Style 222 cartridge housing was created and tested at a flow rate of 1 L/min. The data is presented in Table 7 below.

TABLE 7
Two Layer Cartridge Virus Removal

| Influent Log | Effluent Log | Log Reduction | Pressure Drop |
|---|---|---|---|
| 6.59 | 2.50 | 4.09 | 4.0 psig |
| | | | (1.94 kPA) |

All cited patents, publications, copending applications, and provisional applications referred to in this application are herein incorporated by reference.

The invention being thus described, it will be obvious that the same may be varied in many ways. Such variations are not to be regarded as a departure from the spirit and scope of the present invention, and all such modifications as would be obvious to one skilled in the art are intended to be included within the scope of the following claims. While embodiments have been shown and described, modifications thereof can be made by one skilled in the art without departing from the spirit and teachings of the disclosure. The embodiments described herein are exemplary only, and are not intended to be limiting. Many variations and modifications of the embodiments disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A filtration media, comprising:
one or more carbon nanotube (CNT)-containing layer, comprising:
high temperature refractory fibers that have melting temperatures greater than about 600° C.; and
in situ grown CNTs.

2. The media of claim 1, wherein said high temperature fibers comprise one or more of staple quartz fibers and ceramic refractory fibers.

3. The media of claim 1, further comprising:
one or more support layer, comprising:
high temperature refractory fibers that have melting temperatures greater than about 600° C.;
optionally bulk refractory fibers;
optionally E-glass fibers; and
optionally microglass fibers.

4. The media of claim 3, wherein said microglass fibers have a softening point of about 1000° F. (537.8° C.).

5. The media of claim 1, said media providing at least a 4 log bacteria removal.

6. The media of claim 1, said media having at least a 98% efficiency.

7. The media of claim 1, wherein said media removes viruses from water.

8. The media of claim 1, wherein substantially all of said in situ grown CNTs have one end thereof associated with said fibers.

9. The media of claim 1, wherein substantially all of said in situ grown CNTs extend away from said fibers.

10. The media of claim 1, wherein substantially all of said in situ grown CNTs are dispersed throughout the fibers.

11. A filtration media, comprising:
one or more carbon nanotube (CNT)-containing layer, comprising:
high temperature refractory fibers that have melting temperatures greater than about 600° C.;
in situ grown CNTs; and
one or more support layer, comprising:
high temperature refractory fibers that have melting temperatures greater than about 600° C.;
bulk refractory fibers;
E-glass fibers; and
microglass fibers.

12. The media of claim 11, wherein said microglass fibers have a softening point of about 1000° F. (537.8° C.).

13. The media of claim 11, said media providing at least a 4 log bacteria removal.

14. The media of claim 11, said media having at least a 98% efficiency.

15. The media of claim 11, wherein substantially all of said in situ grown CNTs have one end thereof associated with said fibers.

16. The media of claim 11, wherein substantially all of said in situ grown CNTs extend away from said fibers.

17. The media of claim 11, wherein substantially all of said in situ grown CNTs are dispersed throughout the fibers.
